(19) United States
(12) Patent Application Publication
(10) Pub. No.: US 2025/0144527 A1
(43) Pub. Date: May 8, 2025

(54) METHODS AND SYSTEMS FOR DISTRIBUTED GAMING

(71) Applicant: Comcast Cable Communications, LLC, Philadelphia, PA (US)

(72) Inventors: Michael Chen, Philadelphi, PA (US); Arpit Mathur, Philadelphia, PA (US)

(21) Appl. No.: 18/504,652

(22) Filed: Nov. 8, 2023

(51) Int. Cl. A63F 13/67; A63F 13/358; A63F 13/79

(52) U.S. Cl. CPC A63F 13/67; A63F 13/358; A63F 13/79

(57) ABSTRACT

Methods, systems, and apparatus are described herein for monitoring a gaming environment and adjusting one or more adaptive controls to aid or impair one or more players in the gaming environment so as to achieve a desired result, such as parity among the players.

### BACKGROUND

Players participating in online games may experience network conditions that impact a player's performance in the game. For example, a player may experience increased latency due to traffic routing or decreased bandwidth due to network traffic levels. These network conditions may result in a degraded user experience especially if they result in a reduction in game performance such as losing a game. Currently, if a player is losing a game, regardless of whether the poor performance is due to lack of skill or network conditions, the only remedial actions available are in-game actions such as awarding a losing player a speed boost (e.g., “rubberbanding” in racing games) or some other in-game bonus (e.g., a magic bullet in a first person shooter).

### SUMMARY

It is to be understood that both the following general description and the following detailed description is merely an example and is explanatory only and is not restrictive. Methods, systems, and apparatuses for distributed gaming are described. In the course of participating in an online gaming session, one or more network conditions may impact a gaming environment. The one or more network conditions can be changed in order to influence game play.

### BRIEF DESCRIPTION OF THE DRAWINGS

The accompanying drawings, which are incorporated in and constitute a part of this specification, illustrate embodiments and together with the description, serve to explain the principles:

FIG. 1 is a block diagram of an example system;

FIG. 2 is a table of example gaming environment data;

FIG. 3 is a flowchart of an example method;

FIG. 4 is a flowchart of an example method;

FIG. 5 is a flowchart of an example method; and

FIG. 6 is a block diagram of an example computing device.

### DETAILED DESCRIPTION

Before the present techniques are disclosed and described, it is to be understood that this disclosure is not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to.” and is not intended to exclude, for example, other components, integers or steps. “Exemplary” or “example” means “an example of” and is not intended to convey an indication of a preferred or ideal embodiment. “Such as” is not used in a restrictive sense, but for explanatory purposes.

Disclosed are components that can be used to perform the disclosed content analysis and storage techniques. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present systems and methods may be understood more readily by reference to the following detailed description of preferred embodiments and the examples included therein and to the Figures and their previous and following description.

As will be appreciated by one skilled in the art, the techniques may take the form of an entirely hardware embodiment, an entirely software embodiment, or an embodiment combining software and hardware aspects. Furthermore, the content analysis and storage techniques may take the form of a computer program product on a computer-readable storage medium having computer-readable program instructions (e.g., computer software) embodied in the storage medium. More particularly, the present content analysis and storage techniques may take the form of web-implemented computer software. Any suitable computer-readable storage medium may be utilized including hard disks, CD-ROMs, optical storage devices, or magnetic storage devices.

Embodiments are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

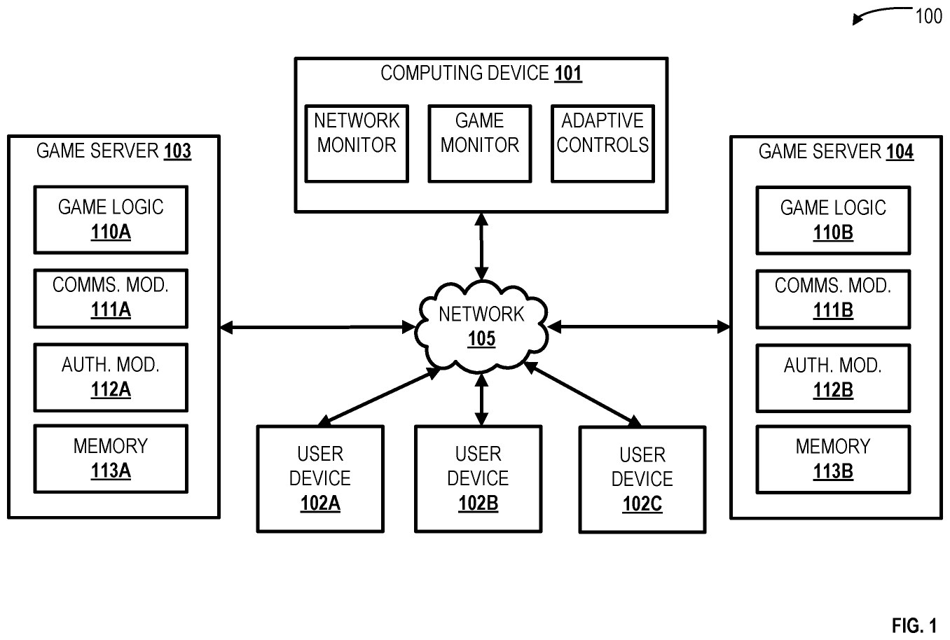

FIG. 1 shows an example system 100 in which the present methods and systems may operate. One skilled in the art will appreciate that provided herein is a functional description and that the respective functions can be performed by software, hardware, or a combination of software and hardware. The system 100 may facilitate content distribution and management. The content may comprise any media such as a video game, an online game, an e-sports game, an online video conference, combinations thereof, and the like. The content may be associated with an application 108.

The system 100 may comprise a computing device 101, one or more user devices 102A-C (which may be referred to collectively as the one or more user devices, one or more client devices, one or more game devices, one or more consoles, combinations thereof, or the like), one or more game servers (e.g., game server 103, game server 104, collectively “the one or more game servers”), through a network 105. For example, the one or more user devices may comprise one or more game consoles (e.g., XBOX, PLAYSTATION), one or more computers (e.g., personal computers, laptops, desktops), one or more mobile devices (e.g., smartphones or the like) or any other device capable of receiving, sending, processing, storing, generating, and/or outputting data. While only user devices 102A, 102B, and 102C are shown, it is to be understood the system 100 may comprise any number of user devices. Likewise, while only two game servers are shown, it is to be understood that the system 100 may comprise any number of game servers. Similarly, the system 100 may comprise any number of computing devices 101. The one or more user devices 102A-C may be in communication with the game servers 103 and 104 through a network 105. The network 105 may comprise any telecommunications network such as the Internet or a local area network. Other forms of communications can be used such as wired or wireless telecommunication channels, for example. The network 105 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. The communication protocols may be universal, generally applicable protocols or they may be game provider specific.

Each user device of the one or more user devices 102A-C may send and receive data to and from each other and the one or more game servers through the network 105. Each user device of the one or more user devices 102A-C may be associated with at least one device capability. Each user device of the one or more user devices 102A-C may be associated with (e.g., configured with) performance information indicating, for example, one or more performance capabilities associated with the user device. The performance information may indicate hardware or software parameters associated with the user device such as a class of device (e.g., whether or not the user device is a game console, a desktop computer, or a smart phone) or one or more hardware, software, or performance specifications associated with the user device (e.g., RAM, processing speed, graphics information, combinations thereof, and the like). The one or more user devices may also send network data associated with the network 105 and/or a local network. For example, the one or more user devices may send to the computing device 101 information related to network latency, bandwidth, packet loss, jitter, round trip time (RTT), throughput, error rate, network utilization, response time, availability, peak usage, connection status, combinations thereof, or the like. The computing device 101 may be configured to determine the performance information and/or the network information by monitoring the network 105 and/or any one or more local networks associated with the one or more user devices.

The one or more game servers 103 and 104 may be any computing device which may receive, process, distribute, and/or output data. The one or more game servers may comprise one or more game logic modules (e.g., game logic modules 110A and 110B), one or more communications modules (e.g., 111A and 111B), one or more authentication/authorization modules 112A, 112B, and one or more memories 113A and 113B. The game logic modules may be configured to simulate a game world, control game rules, manage game mechanics, game physics, AI behavior (e.g., non-player characters or “NPCs”), and other aspects of the game. The communications modules may be configured to handle communications (e.g., sending, receiving, processing, storing data) sent, from, or between the various devices the system. The communications modules may be configured to facilitate voice chat, video capabilities, and/or in-game messaging. The authentication/authorization modules may be configured to verify player identities to ensure that only authorized/authenticated players (e.g. users) are participating in the game. The memories 113A and 113B may be configured to store persistent and nonpersistent data related to the game such as player progress, achievements, inventories, and other relevant information. The game servers may be configured with load balancers, auto-scaling mechanisms, monitoring mechanisms and logging mechanisms. The one or more game servers may be configured with matchmaking capabilities configured to group players with similar skill levels or game preferences together so as to create balanced, competitive gaming experiences.

The computing device 101 may comprise a network monitoring module, a game monitoring module, and an adaptive controls module. The network monitoring module may be configured to determine one or more network conditions associated with a gaming environment comprising the one or more user devices 102A-C. The one or more network conditions may comprise, for example, latency, lag, available bandwidth, consumed bandwidth, error rate, packet loss, jitter, round-trip-time (RTT), buffer bloat, network address translation issues, quality of service settings, network interference, server location, distributed denial of server (DDOS) attacks, combinations thereof, and the like. For example, the network monitoring module may be configured to determine lag, latency, bandwidth, round-trip-time, packet loss, or any other network information associated with the network 105 and/or any local area networks associated with the one or more user devices 102A-C. For example, the network monitoring module may determine a first user device 102A has a latency of 10 ms and a packet loss of 10%, a second user device 102B has a latency of 500 ms and a packet loss of 10%, and a third user device 102C has a latency of 1000 ms and a packet loss of 10%. The aforementioned are merely exemplary and explanatory and a person skilled in the art will appreciate that the network monitoring module may be configured to determine any information about the network 105 and/or any local area networks associated any of the one or more user devices 102A-C.

The computing device 101 may comprise a game monitor. The game monitor may be configured to determine game information about a game in which one or more players associated with the one or more user devices 102A-C are participating. For example, the game monitor may send and receive information from the one or more game servers to determine, for example, one or more game metrics, one or more scores, one or more progress indications, or any other information related to game play. The game may be hosted, for example, on the one or more game servers. In some cases, the game may be hosted on a single server wherein the single server handles all aspects of the game including managing player interactions, game logic, and data storage. In some cases, the game may be hosted on more than one server. For example, there might be separate servers responsible for authentication, matchmaking, game logic, and player data storage. In some cases, the game may be hosted on and carried out via a content distribution network (CDN). The CDN may comprise one or more servers strategically placed in various geographic locations to ensure that players can download content from nearby servers, reducing latency and improving download speeds. In some cases, the game may be configured as a peer-to-peer (P2P) game wherein user devices may connect directly to other user devices for gameplay, rather than relying solely on centralized servers. P2P can reduce the strain on central servers and also be utilized in some instances as a load-balancing technique. In some cases, the game may be hosted in a hybrid environment using a combination of centralized servers and P2P connections. For example, while the main game logic might be handled by centralized servers, certain aspects of gameplay, like player interactions or trading, may occur directly between players using P2P connections.

The computing device may comprise an adaptive controls module. The adaptive controls module may be configured to adjust one or more network conditions and/or one or more game conditions. For example, the adaptive controls module may be configured to change which game server of the one or more game servers is hosting the game. For example, the first game server 103 may be located on the west coast while the second game server 104 is located on the east coast. The user devices 102A and 102B may also be located on the west coast. The user device 102C may be located on the east coast. The game may initially be hosted on the first game server 103. The adaptive controls module may be configured to cause the game to be hosted on the second gamer server 104 rather than the first game server 103. For example, the adaptive controls module may be configured to cause the game to be hosted on the second gamer server 104 rather than the first game server 103 in response to a determination that the user device 102C is associated with an RTT that is significantly longer than the RTTs associated with user devices 102A and 102B.

For example, the adaptive controls module may be configured to cause an increase in bandwidth available to the first user device 102A. For example, the adaptive controls module may be configured for quality of service (QOS) management. For example, the adaptive controls module may be configured to determine and/or adjust one or more quality of service (QOS) levels. For example, QOS mechanisms may allow the computing device to prioritize certain types of network traffic over others. By assigning different levels of priority to different types of data (such as video streams, voice calls, or regular web browsing), the server can ensure that certain traffic (e.g., traffic associatd with a first user device 102A) gets higher bandwidth allocation while other traffic (e.g., traffic associated with a second user device 102B) gets lower bandwidth allocation.

The adaptive controls module may be configured for traffic shaping. Traffic shaping involves controlling the flow of data to ensure that it conforms to certain parameters. By setting up traffic shaping rules on the central computing device, the computing device can limit the rate of data transmission for specific devices or applications. Traffic policing involves enforcing predefined limits on data rates. For example, traffic shaping may prevent any single user or application from consuming excessive bandwidth.

The adaptive controls module may be configured for bandwidth reservation. For example, the computing device may allocate dedicated portions of available bandwidth to specific user devices. This approach is commonly used in scenarios where certain devices or applications require a guaranteed amount of bandwidth for optimal performance. By reserving bandwidth for critical tasks, the server ensures that these tasks won't be adversely affected by fluctuations in network load.

The adaptive controls module may be configured for dynamic bandwidth allocation. For example, the adaptive controls module may dynamically adjust the allocation of bandwidth based on real-time network conditions and user demand. If the network is experiencing congestion, the server might decrease the available bandwidth for each user to ensure fair sharing. Conversely, during periods of lower demand, the server can allocate more bandwidth to improve user experience.

The adaptive controls module may be configured to congestion control and load balancing. For example, the adaptive controls module may reduce the available bandwidth for certain users or applications temporarily. Load balancing techniques might also be employed to distribute network traffic evenly across multiple servers (e.g., the one or more game servers), preventing any single server from becoming a bottleneck and affecting bandwidth availability.

The adaptive controls module may be configured to manipulate latency associated with the one or more user devices. For example, the adaptive controls module may be configured to adjust server location and/or geographic proximity. For example, the adaptive controls module may assign certain computing tasks to certain game servers based on their geographic location and/or based on network proximity with respect to the one or more user devices. For example, designating a central server strategically in a location that minimizes the physical distance to the majority of players can help reduce latency. Players closer to the server will experience lower latency compared to those who are farther away. Further, the computing device may change which server hosts which function of the game in order to adjust the latency experienced by the one or more players. For example, the adaptive controls module may, based on a determination by the game monitoring module that a first player associated with the first user device 102A is losing, migrate the game to the game server closer to the user first user device 102A in order to give that player an advantage and thus create a competitive balance between the players.

The game monitor, adaptive controls module, the one or more game servers may be configured with predictive game mechanics. For example, the computing device and/or one or more game servers may be configured with predictive algorithms that anticipate the actions of players and compensate for latency. For example, the computing device might predict the trajectory of a moving object based on its last known position and velocity.

The computing device may be configured to implement one or more lag compensation techniques. For example, the computing device 101 may be configured for interpolation, extrapolation, server-side lag compensation, hitbox and collision adjustment, time synchronization, frame delay, region locking, and matchmaking. For example, interpolation involves estimating the position of moving objects based on their previous positions. When a player's device receives an update about the position of another player, it doesn't immediately jump to that new position due to latency. Instead, the game smoothly transitions the object's position using interpolation, creating a more natural movement appearance. For example, extrapolation is similar to interpolation but involves estimating future positions of objects. This can be especially useful for fast-moving objects like projectiles. By predicting where an object will be based on its current trajectory, the game can help compensate for the delay caused by latency.

In server side lag compensation, servers can rewind a game state to account for the latency of different players. For example, if Player A shoots at Player B but Player B's client has a delay, the server might rewind Player A's shot to the point when it should have hit according to Player B's latency. This ensures that interactions are fair despite latency differences. In hitbox and collision adjustment, in order to account for latency, the hitboxes (the areas on a character that can be hit) can be adjusted on the client side based on latency estimates. Similarly, collision detection can be adjusted to account for the fact that players' positions might be slightly behind where they appear on their screens.

The adaptive controls module may be configured to adjust one or more in-game parameters. For example, the adaptive controls module may be configured to cause an in-game enhancement such as a graphic foveation, adjust a processing priority for game commands received by the one or more user devices, or provide in-game bonuses or boosts. For example, the adaptive controls module may prioritize commands received from the first user device 102A.

The present methods and systems improve the functioning of gaming computing and other gaming technologies or technical fields by more accurately allocating computing resources and dynamically altering the computing environment (e.g., by migrating a game to a different server, or taking other remedial network actions) in order to reduce gaming experience degradation such as lack of parity attributable to network or other gaming environment conditions beyond player skill. Current solutions are limited to in-game actions such as in-game bonuses or handicaps while the present methods and systems adjust network conditions to achieve similar results. Further, any current dynamic network resource modifications are agnostic with respect to game-play (e.g., winning/losing) and focus solely on network metrics and do not take into account the gaming experience of the players.

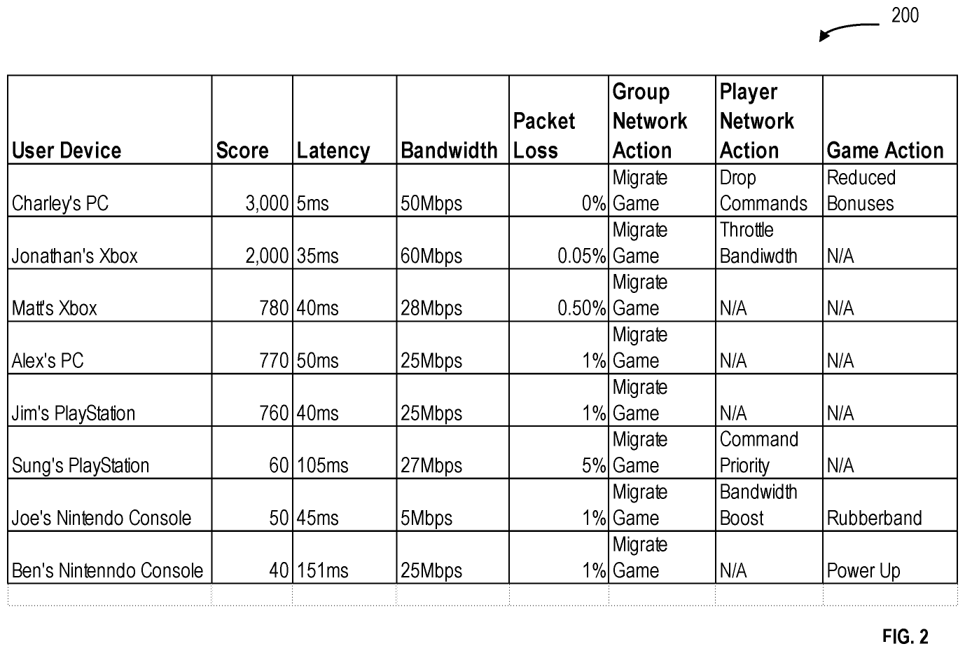

FIG. 2 shows example game environment data 200. The game environment data 200 may comprise game data. The game data may comprise (indicate) one or more user devices (e.g., one or more user device identifiers), one or more game states, one or more game metrics, one or more network conditions, one or more network actions, and/or one or more game actions. The one or more user device identifiers may indicate an association with one or more users. The one or more user device identifiers may indicate a make and/or model of the one or more user devices. The one or more smart device identifiers may indicate a manufacturer, a model, and one or more functionalities and/or configurations. For example, a user may register a user device and during registration and may indicate one or more device capabilities associated with the user device (or the system may determine the one or more device capabilities associated with the user device).

The example game environment data 200 indicates one or more user devices (e.g., user device identifiers). The one or more user device identifiers may indicate an association with one or more users. The one or more user device identifiers may indicate a make and/or model of the one or more user devices. The one or more smart device identifiers may indicate a manufacturer, a model, and one or more functionalities and/or configurations. For example, a user may register a user device and during registration and may indicate one or more device capabilities associated with the user device (or the system may determine the one or more device capabilities associated with the user device).

The game environment data 200 may indicate one or more scores. The one or more scores shown in FIG. 2 are merely exemplary and explanatory and should not be considered limiting. For example, in a first person shooter game, the one or more scores may be “kills” or a “kill to death ratio.” Meanwhile, in a racing game, the one or more scores may be positions relative to other players (e.g., first place, second place, last place, and so on). In puzzle games the scores may indicate points or levels. A person skilled in the art will recognize the scores may be any scores measured using any metric.

The game environment data may indicate one or more network conditions. For example, the example game environment data 200 indicates latency, bandwidth, and packet loss associated with the one or more user devices. The aforementioned are merely exemplary and explanatory and are not intended to be limiting. A person skilled in the art will appreciate that any network condition(s) may be included in the game environment data 200. Latency is a problem because high latency may cause lag that makes gaming far less enjoyable. Low latency is ideal as this means a player will experience smoother gameplay (e.g., there will be little delay between an input at the user device, processing of the input at the game server, and output of any updated graphics information or updating of other game data as a result of the input and said information will be relayed to the given player quickly). Generally, an acceptable latency (a latency that is not noticeable to the user and does not impact game play) is anywhere around 40-60 milliseconds (ms) or lower, while a latency of over 100 ms will usually mean a noticeable lag in gaming. Meanwhile, in gaming, a packet loss rate of between 1-2% is seen as acceptable. Packet loss is typically higher on wireless networks than wired networks.

The system may be configured to determine one or more network conditions associated with the one or more user devices participating in a game. The system may be configured to determine the one or more network conditions satisfy or do not satisfy one or more thresholds. The one or more thresholds may be absolute or relative. The one or more latency thresholds may be determined based on the game. For example, a first game may be associated with one or more first latency thresholds and a second game may be associated with one or more second latency thresholds.

For example, a first latency threshold may be an absolute latency threshold. For example, the first latency threshold may be set at 150 ms. Thus, the latency experienced by Ben's Nintendo Console satisfies the first latency threshold. Therefore, Ben's Nintendo Console may be eligible for one or more corrective (e.g., compensatory) network actions or game actions. For example, in order to reduce the latency experienced by Ben's Nintendo Console, the adaptive controls module may migrate the game from a first server to a server located closer to Ben's Nintendo Console.

For example, a second latency threshold be a relative latency threshold (e.g., how the latency experienced by a first user device compares to one or more latencies experienced by one or more other user devices). For example, the second latency threshold, as it relates to a first user device, may be set at 2× the average of the remaining user devices. For example, in the example game data 200, with respect to the latency experienced by Sung's PlayStation, the average of the latency experienced by the remaining user device (e.g., all the devices except for Sung's PlayStation) is 52 ms. Thus, any latency that is greater than 104 ms satisfies the second (relative) latency threshold. Sung's PlayStation is experiencing 105 ms of latency and thus satisfies the second latency threshold. Therefore, Sung's PlayStation may be eligible for one or more corrective network actions or game actions.

Similarly, the system may determine one or more bandwidth's available to the one or more user devices and determine the one or more bandwidth's available to the one or more user devices satisfy or do not satisfy one or more bandwidth thresholds. For example, the one or more bandwidth thresholds may be absolute thresholds and/or relative thresholds. The one or more thresholds may be determined based on the game. For example, a first game may be associated with one or more first bandwidth thresholds and a second game may be associated with one or more second bandwidth thresholds. For example, an absolute bandwidth threshold may be 10 Mbps and any user device experiencing less than 10 Mbps may be eligible for a remedial network action. For example, Joe's Nintendo Console is experiencing 5 Mbps bandwidth and therefore is eligible for a corrective network action such as, for example, a bandwidth boost. Thus, the adaptive controls module may dedicate more computing resources (e.g., bandwidth) to Joe's Nintendo Console. The one or more bandwidth thresholds may be relative as well. As described above, the one or more relative thresholds may be functions of one or more network conditions such as a bandwidth that is less than one half the average bandwidth experienced by the remaining players in a group or other similar relative thresholds.

The system may be configured to determine, for example, one or more packet loss rates and one or more packet loss rate thresholds. Like the other network condition thresholds, the one or more packet loss rate thresholds may be absolute or relative. For example, a first (absolute) packet loss rate threshold may be set at 4% and thus, any user device experiencing a packet loss rate greater than 4% may be eligible for one or more remedial network condition actions and/or one or more remedial game actions. For example, Sung's PlayStation is experiencing a packet loss rate of 5% and thus is eligible for one or more remedial network condition actions and/or one or more remedial game actions. For example, the adaptive controls module may give commands received from Sung's PlayStation a relatively higher processing priority in order to make up for the increased packet loss rate.

In addition to aiding players whose user devices are suffering network condition deficiencies, the system may be configured to handicap players whose user devices are experiencing relatively few network condition deficiencies, or are simply outperforming the other players. For example, Charley's PC is experiencing virtually no latency (e.g., 5 ms), and his score is relatively high compared to the other players in the gaming environment. Thus, Charley's PC may be handicapped by, for example, “dropping” (e.g., not executing) one or more commands received from Charley's PC. Similarly, commands received from one or more user devices whose players are underperforming due to either a network condition or simple lack of skill may be eligible for performance increases such as a command processing priority, or even in-game actions such as bonus boosters, rubberbanding (e.g., in a racing game), or other performance enhancers.

The system may be configured to determine and activate the one or more remedial network actions and or game actions so as to increase parity among players. For example, the adaptive controls module may increase bandwidth and/or reduce latency for a given player who is losing, until that player “catches up” or achieves a relatively more equal score, at which point, the system may return to default settings and stop throttling bandwidth or latency.

Other alternative exits such as foveation, rendering, or encoding enhancements that may be configured to, for example, increase clarity and detail of important points of interest in a rendered frame (e.g., where a player is aiming). Additional periphery data may be gathered such as eye tracking of the user in order to determine where the user is looking and increase the clarity of that area on the screen.

Additional, non-network condition may be gathered to determine a user's experience. For example, audio data may be gathered. For example, a user may speak into a microphone and natural language processing and tonal analysis may be used to determine whether the player is enjoying the game or is experiencing frustration or other emotions.

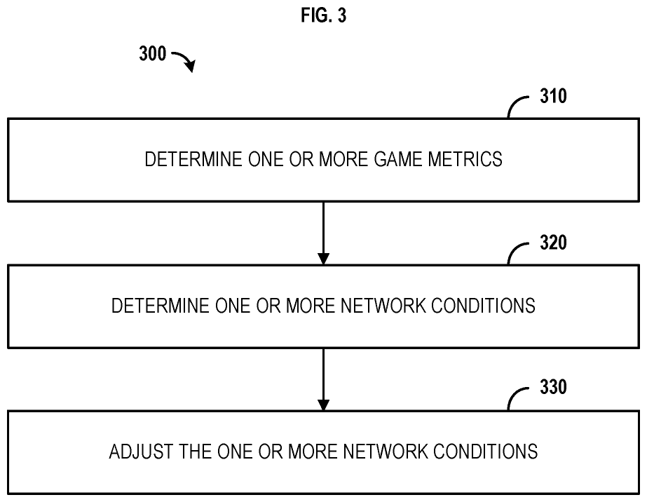

FIG. 3 shows a flowchart of an example method 300. The method 300 may be carried out on any one or more devices. For example, the method 300 may be carried out on any one or more devices described herein such as those in FIG. 1.

At 310, a computing device (e.g., the computing device 101) may determine one or more game metrics associated with one or more players participating in a networked game conducted via a multiplayer gaming environment. The one or more game metrics may comprise, for example, one or more in-game performance metrics associated with the one or more players (e.g., scores, positions, levels, kills, deaths, etc.) and one or more computing resource metrics associated with the networked gaming session (e.g., cpu resource consumption, graphics processing resources, bandwidth, etc. . . . ). The one or more game metrics may comprise, for example, the one or more in-game performance metrics, but not the one or more computing resource metrics. The one or more game metrics may comprise, for example, the one or more computing resource metrics, but not the one or more in-game performance metrics. Determining the one or more game metrics associated with the one or more players of the networked game may comprise monitoring the multiplayer gaming environment. The multiplayer gaming environment may be any gaming environment including a local gaming session (e.g., where players are local to one-another, a massive(ly) multiplayer online game (MMRO), or any other type of multiplayer gaming environment. The multiplayer gaming environment may comprise one or more game servers, one or more user devices, one or more network devices, combinations thereof, and the like. One or more players may participate in the multiplayer gaming environment. The one or more players may be associated with the one or more user devices. For example, a first player may be associated with a first user device, a second player may be associated with a second user device, and so on. The one or more user devices may comprise one or more computers (e.g., one or more PCs), one or more smart phones, one or more tablet computers, one or more laptop computers, one or more gaming consoles, combinations thereof, and the like. The one or more user devices may be configured to receive one or more user inputs, output one or more outputs, send and receive gaming data, and otherwise facilitate the participation of one or more players in a game in the online gaming environment.

At 320, one or more network conditions associated with the multiplayer gaming environment may be determined. The one or more network conditions associated with the multiplayer gaming environment may be determined based on determining a difference between the one or more game metrics satisfies a threshold. For example, it may be determined a given player's performance drops below a threshold (e.g., two standard deviations below the mean or median of other players participating in the game). The aforementioned is merely exemplary and explanatory and not limiting. The threshold may be any threshold. The one or more network conditions may impact player experience. The one or more network conditions may comprise, for example, latency, lag, available bandwidth, consumed bandwidth, error rate, packet loss, jitter, round-trip-time (RTT), buffer bloat, network address translation issues, quality of service settings, network interference, server location, distributed denial of server (DDOS) attacks, combinations thereof, and the like.

The one or more network conditions may be determined based on, for example, one or more game states (e.g., one or more game metrics) associated with the game. A game state may comprise a representation of all relevant data and variables that define the status, progress, and conditions of a video game at a specific moment in time including game metrics such as scores or other in-game data. This includes information about the positions of in-game objects, characters, items, their attributes, scores, level progression, user inputs, and various other parameters that collectively determine the state of the game world. The game state may be updated based on user inputs and game logic. The game state may be maintained by one or more game engines (e.g., housed at the one or more game servers) to ensure consistent gameplay experiences and to facilitate real-time interactions between players and gaming environment.

The computing device may be configured with one or more adaptive controls. The one or more adaptive controls may be configured adjust the one or more network conditions as described herein. For example, a first adaptive control of the one or more adaptive controls may be configured to cause a game session to migrate from a first game server to a second game server. For example, a second adaptive control of the one or more adaptive controls may be configured to throttle bandwidth or other network resources.

At 330, the one or more network conditions of the multiplayer gaming environment may be adjusted via the one or more adaptive controls. For example, the one or more network conditions may be adjusted based on one or more game states (e.g., one or more game metrics) to increase parity among game participants. For example, it may be determined that a first player is losing the game by a wide margin. It may be determined that the player is losing due to either poor play or due to a network condition such as latency. The adaptive controls module may take remedial action such as, decreasing the latency associated with the player (e.g., associated with the player's user device) until that latency is relatively more equal to latency experienced by other players. Conversely, the adaptive controls module may increase latency for all other players. The adaptive controls module may migrate the gaming session to a game server closer to the first player in order to reduce the latency. The adaptive controls module may introduce processing delays for other players in order to increase the latency experienced by the other players. Adjusting the network condition to correct the deficiency may comprise adjusting the network condition to improve the in-game performance of the one or more players associated with the one or more client devices. Adjusting the network condition to correct the deficiency may comprise adjusting the network condition to degrade the in-game performance of the one or more players associated with the one or more client devices.

The method may comprise determining a deficiency in a network condition associated with a user device. The method may comprise associating the deficiency in the network condition with game data such as a game state and/or a game metric. For example, the method may comprise determining an expected performance level of a first player, determining a difference between the expected performance level of the first player and an actual performance level of the first player, and attributing the difference between the expected performance level and the actual performance level to the deficiency in the network condition. For example, the computing device may determine a gaming history associated with a player account associated with a user device of the first player. The method may comprise determining a game state associated with the networked gaming session. The method may comprise determining one or more game metrics associated with the networked gaming session.

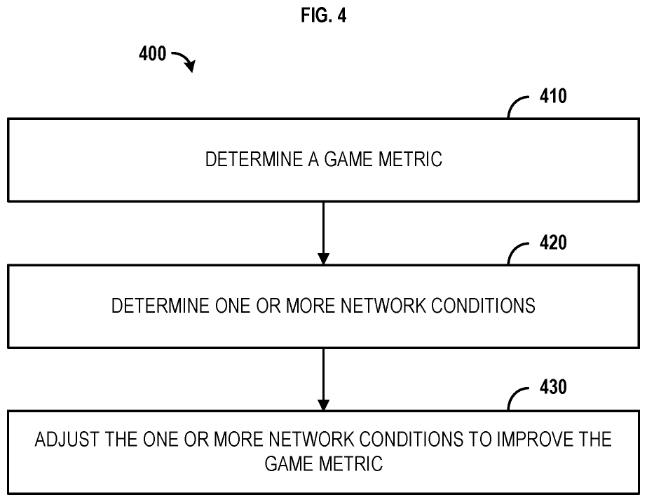

FIG. 4 shows a flowchart of an example method 400. The method 400 may be carried out on any one or more devices. For example, the method 400 may be carried out on any one or more devices described herein such as those in FIG. 1. At 410, a computing device (e.g., the computing device 101) may determine a game metric of one or more game metrics associated with a player of one or more players participating in a networked gaming session. The one or more game metrics may comprise, for example, one or more in-game performance metrics associated with the one or more players (e.g., scores, positions, levels, kills, deaths, etc.) and one or more computing resource metrics associated with the networked gaming session (e.g., cpu resource consumption, graphics processing resources, bandwidth, etc. . . . ). The one or more game metrics may comprise, for example, the one or more in-game performance metrics, but not the one or more computing resource metrics. The one or more game metrics may comprise, for example, the one or more computing resource metrics, but not the one or more in-game performance metrics.

The networked gaming session may be conducted via a multiplayer gaming environment. The multiplayer gaming environment may comprise one or more user devices associated with one or more players. The multiplayer gaming environment may comprise one or more game servers, one or more access points, one or more gateways, one or more wide area networks (WANs), one or more local area network (LANs), one or more headends, combinations thereof, and the like. The one or more user devices may be configured to receive one or more user inputs, output one or more outputs, send and receive gaming data, and otherwise facilitate the participation of one or more players in a game in the online gaming environment.

The one or more players may be associated with the one or more user devices. For example, a first player may be associated with a first user device, a second player may be associated with a second user device, and so on. The one or more user devices may comprise one or more computers (e.g., one or more PCs), one or more smart phones, one or more tablet computers, one or more laptop computers, one or more gaming consoles, combinations thereof, and the like. The game metric may be included in a game state. The game state may comprise one or more representations of all relevant data and variables that define the status, progress, and conditions of a video game at a specific moment in time including one or more in-game performance metrics. This includes information about the positions of in-game objects, characters, items, their attributes, scores, level progression, user inputs, and various other parameters that collectively determine the state of the game world. The game state may be updated based on user inputs and game logic. The game state may be maintained by one or more game engines (e.g., housed at the one or more game servers) to ensure consistent gameplay experiences and to facilitate real-time interactions between players and gaming environment.

At 420, one or more network conditions associated with a user device of the one or more user devices. The user device may be associated with a player. The one or more network conditions associated with a user device of the one or more user devices may be determined based on the game metric. The one or more network conditions may comprise, for example, latency, lag, available bandwidth, consumed bandwidth, error rate, packet loss, jitter, round-trip-time (RTT), buffer bloat, network address translation issues, quality of service settings, network interference, server location, distributed denial of server (DDOS) attacks, combinations thereof, and the like. For example, the network monitoring module may be configured to determine lag, latency, bandwidth, round-trip-time, packet loss, or any other network information. The one or more network conditions may be determined based on one or more game states.

At 430, the one or more network conditions associated with the user device may be adjusted to improve the game metric associated with the player. For example, if a given player's performance drops below a threshold (e.g., two standard deviations below the mean or median of other players participating in the game), it may be determined whether or not there is an opportunity to increase that player's performance by, for example, adjusting one or more network conditions (e.g., reduce that player's latency, move the game to a server nearer that player, increase that player's command processing priority, drop commands from other players, or any other adjustment). For example, when it is determined that a give player is significantly outperforming other players or underperforming as compared to other players, the one or more network conditions may be determined

The method may comprise monitoring one or more network conditions associated with a networked gaming session comprising one or more user devices. The method may comprise determining a difference between the one or more network conditions associated with the user device and one or more network conditions associated with one or more other user devices satisfies a threshold. The method may comprise adjusting the network condition to degrade an in-game performance of the one or more players associated with the one or more user devices. The method may comprise determining the game metric associated with the player has improved. The method may comprise returning the one or more network conditions to an unadjusted level based on determining the game metric associated with the player has improved.

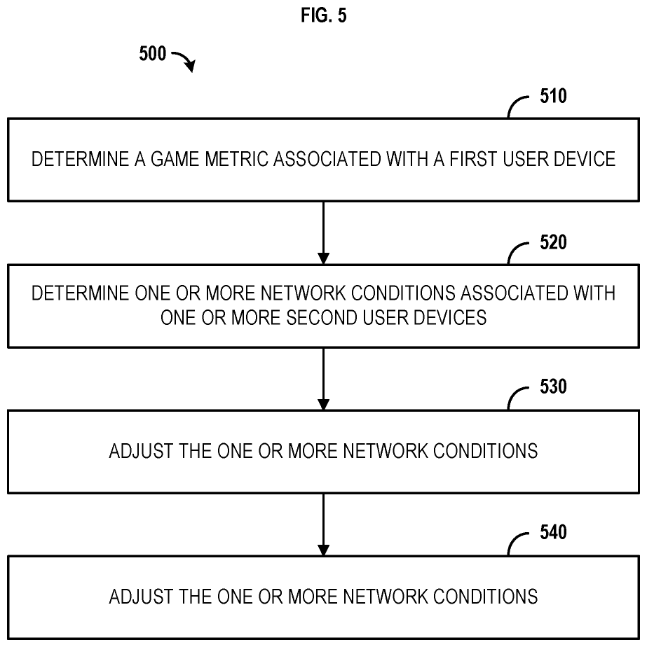

FIG. 5 shows a flowchart of an example method 500. The method 500 may be carried out on any one or more devices. For example, the method 500 may be carried out on any one or more devices described herein such as those in FIG. 1. At step 510, a computing device (e.g., the computing device 101) may determine a game metric associated with a first user device of one or more user devices. The one or more user devices may be participating in a networked gaming session. The one or more user devices may comprise one or more computers (e.g., one or more PCs), one or more smart phones, one or more tablet computers, one or more laptop computers, one or more gaming consoles, combinations thereof, and the like. The one or more user devices may be configured to receive one or more user inputs, output one or more outputs, send and receive gaming data, and otherwise facilitate the participation of one or more players in a game in the online gaming environment. The one or more user devices may be associated with one or more players.

The first user device of the one or more user devices may be associated with a first player of one or more players. The game metric may be a game metric of one or more game metrics. The one or more game metrics may comprise, for example, one or more in-game performance metrics associated with the one or more players (e.g., scores, positions, levels, kills, deaths, etc.) and one or more computing resource metrics associated with the networked gaming session (e.g., cpu resource consumption, graphics processing resources, bandwidth, etc. . . . ). The one or more game metrics may comprise, for example, the one or more in-game performance metrics, but not the one or more computing resource metrics. The one or more game metrics may comprise, for example, the one or more computing resource metrics, but not the one or more in-game performance metrics.

The one or more game metrics may be included in a game state. The game state may comprise a representation of all relevant data and variables that define the status, progress, and conditions of a video game at a specific moment in time including in-game performance metrics (e.g., game metric). This includes information about the positions of in-game objects, characters, items, their attributes, scores, level progression, user inputs, and various other parameters that collectively determine the state of the game world. The game state may be updated based on user inputs and game logic. The game state may be maintained by one or more game engines (e.g., housed at the one or more game servers) to ensure consistent gameplay experiences and to facilitate real-time interactions between players and gaming environment.

At 520, one or more network conditions associated with one or more second user devices of the one or more user devices may be determined. The one or more network conditions associated with the one or more second user devices may be determined based on determining on the game metric associated with the first player. For example, the computing device may be configured to monitor one or more network conditions associated with a networked gaming session.

At step 530, the one or more network conditions associated with the one or more second user devices may be adjusted. The one or more network conditions associated with the one or more second user devices may be adjusted so as to improve the game metric associated with the first player. For example, when it is determined that a give player is significantly outperforming other players or underperforming as compared to other players, the one or more network conditions may be determined. For example, if a given player's performance drops below a threshold (e.g., two standard deviations below the mean or median of other players participating in the game), it may be determined whether or not there is an opportunity to increase that player's performance by, for example, adjusting one or more network conditions (e.g., reduce that player's latency, move the game to a server nearer that player, increase that player's command processing priority, drop commands from other players, or any other adjustment).

The method may comprise determining a difference between the one or more network conditions associated with the user device and one or more network conditions associated with one or more other user devices satisfies a threshold. The method may comprise adjusting the network condition to degrade an in-game performance of the one or more players associated with the one or more user devices. The method may comprise determining the game metric associated with the player has improved. The method may comprise returning the one or more network conditions to an unadjusted level based on determining the game metric associated with the player has improved.

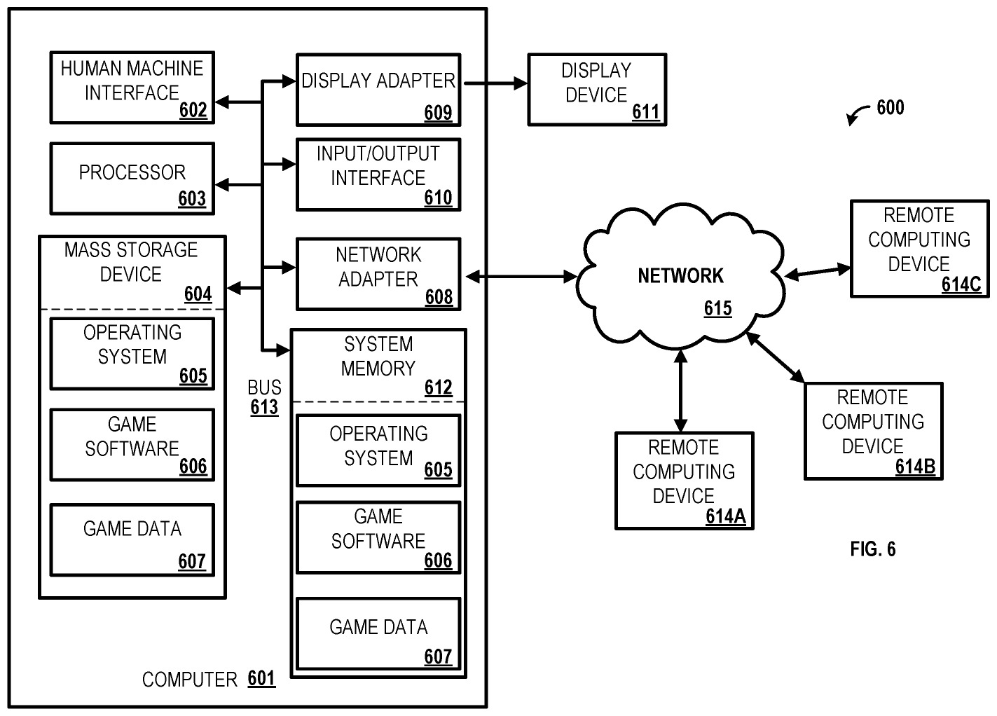

The above described disclosure may be implemented on a computer 601 as illustrated in FIG. 6 and described below. By way of example, game server 104 of FIG. 1 can be a computer as illustrated in FIG. 6. Similarly, user device 102 may be a computer as illustrated in FIG. 6. Likewise, the game server 104 or the user device 102 may be a remote computing device (e.g., remote computing devices 614A, 614B, or 614C) of FIG. 6. FIG. 6 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program elements, being executed by one or more computers or other devices. Generally, program elements comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program elements can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, gaming software 606, gaming data 607, a network adapter 608, the system memory 612, an Input/Output Interface 610, a display adapter 609, a display device 611, and a human machine interface 602, can be contained within one or more remote computing devices 614A, 614B, 614C at physically separate locations, connected through buses of this form, in effect implementing a fully distributed system.

The computer 601 typically comprises a variety of computer readable media. Example readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the gaming data 607 and/or program elements such as the operating system 605 and the gaming software 606 that are immediately accessible to and/or are presently operated on by the one or more processors 603.

The computer 601 can also comprise other removable/non-removable, volatile/non-volatile computer storage media. By way of example, FIG. 6 illustrates the mass storage device 604 which can facilitate non-volatile storage of computer code, computer readable instructions, data structures, program elements, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program elements can be stored on the mass storage device 604, including by way of example, the operating system 605 and the gaming software 606. Each of the operating system 605 and the gaming software 606 (or some combination thereof) can comprise elements of the programming and the gaming software 606. The gaming data 607 can also be stored on the mass storage device 604. The gaming data 607 can be stored in any of one or more databases known in the art. Examples of such databases comprise, DB2®, Microsoft® Access, Microsoft® SQL Server, Oracle®, mySQL, PostgreSQL, Mongo, Cassandra, and the like. The databases can be centralized or distributed across multiple systems.

The user or device can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

The display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), an augmented reality (AR) display, a virtual reality (VR) display, a projector, combinations thereof, and the like. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614A. 614B, 614C. By way of example, a remote computing device can be a gaming system, personal computer, portable computer, smartphone, a server, a router, a network computer, a peer device or other common network node, and so on. Logical connections between the computer 601 and a remote computing device 614A, 614B, 614C can be made via a network 616, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the selective gaming software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program elements, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

What is claimed is:

1. A method comprising:
determining, one or more game metrics associated with one or more players of a networked game conducted via a multiplayer gaming environment;
based on a difference between the one or more game metrics associated with the one or more players satisfying one or more thresholds, determining one or more network conditions associated with the multiplayer gaming environment, wherein the one or more network conditions are associated with one or more adaptive controls; and
adjusting, via the one or more adaptive controls, the one or more network conditions of the multiplayer gaming environment to create parity among the one or more game metrics.

2. The method of claim 1, wherein the multiplayer gaming environment comprises one or more of: one or more game servers, one or more wide area networks, one or more local area networks, and one or more user devices and wherein the one or more network conditions comprise one or more of latency, lag, available bandwidth, consumed bandwidth, quality of service, command processing priority, graphics resolution, CPU space, server location, ping time, packet loss, network jitter, player position discrepancies, combinations thereof, or the like.

3. The method of claim 1, wherein determining the difference between the one or more game metrics associated with the one or more players satisfies the one or more thresholds comprises determining the one or more game metrics is greater than one standard deviation from an average of the one or more players.

4. The method of claim 1, further comprising:
determining a deficiency of a network condition; and
associating the deficiency of the network condition with the game metric.

5. The method of claim 1, further comprising:
determining the one or more game metrics no longer satisfy the one or more thresholds; and
returning the one or more network conditions to a pre-adjustment level.

6. The method of claim 1, wherein adjusting the one or more network conditions to create parity among the one or more game metrics comprises adjusting the one or more network conditions until the difference in the one or more game metrics satisfies one or more second thresholds.

7. The method of claim 1, further comprising adjusting the one or more network conditions to degrade or improve an in-game performance of the one or more players associated with one or more user devices.

8. A method comprising:
determining a game metric associated with a player of one or more players participating in a networked gaming session conducted via a multiplayer gaming environment, wherein the multiplayer gaming environment comprises one or more user devices associated with the one or more players;
determining, based on the game metric, one or more network conditions associated with a user device of the one or more user devices, wherein the user device is associated with the player; and
adjusting, via one or more adaptive controls, the one or more network conditions associated with the user device to improve the game metric associated with the player.

9. The method of claim 8, wherein the multiplayer gaming environment comprises one or more of: one or more game servers, one or more wide area networks, one or more local area networks, and the one or more user devices and wherein the one or more network conditions comprise one or more of latency, lag, available bandwidth, consumed bandwidth, quality of service, command processing priority, graphics resolution, CPU space, server location, ping time, packet loss, network jitter, player position discrepancies, combinations thereof, or the like.

10. The method of claim 8, wherein determining the game metric associated with the player comprises determining an in-game performance of the player.

11. The method of claim 8, further comprising determining the one or more network conditions are at least partially responsible for the game metric associated with the player.

12. The method of claim 8, further comprising determining a difference between the one or more network conditions associated with the user device and one or more network conditions associated with one or more other user devices satisfies a threshold.

13. The method of claim 8, further comprising adjusting the one or more network conditions to degrade an in-game performance of the one or more players associated with the one or more user devices.

14. The method of claim 8, further comprising:
determining the game metric has improved; and
returning the one or more network conditions to a default state.

15. A method comprising:
determining a game metric associated with a first user device of one or more user devices participating in a networked gaming session, wherein the first user device of the one or more user devices is associated with a first player;
determining, based on the game metric, one or more network conditions associated with one or more second user devices of the one or more user devices; and
adjusting the one or more network conditions associated with the one or more second user devices to penalize one or more second players associated with the one or more second user devices.

16. The method of claim 15, wherein the one or more network conditions comprise one or more of latency, lag, available bandwidth, consumed bandwidth, command processing priority, graphics resolution, CPU space, server location, ping time, packet loss, network jitter, player position discrepancies, combinations thereof, or the like.

17. The method of claim 15, wherein the networked gaming session comprises an online gaming session.

18. The method of claim 15, further comprising determining the game metric associated with the first player satisfies a threshold related to a same game metric associated with the one or more second players.

19. The method of claim 15, wherein adjusting the one or more network conditions comprises adjusting the one or more network conditions to create parity among the one or more players.

20. The method of claim 15, further comprising causing an in-game action configured to penalize the one or more second players.
